(19) United States
(12) Patent Application Publication
(10) Pub. No.: US 2017/0331949 A1
(43) Pub. Date: Nov. 16, 2017

(54) AUTOMATED CALL HANDLING BASED ON CONTEXT OF CALL

(71) Applicant: International Business Machines Corporation, Armonk, NY (US)

(72) Inventors: Gregory J. Boss, Saginaw, MI (US); Andrew R. Jones, Round Rock, TX (US); Charles S. Lingafelt, Durham, NC (US); Kevin C. McConnell, Austin, TX (US); John E. Moore, JR., Brownsburg, IN (US)

(21) Appl. No.: 15/151,905

(22) Filed: May 11, 2016

(51) Int. Cl. H04M 3/42; H04M 1/2745; H04M 3/436

(52) U.S. Cl. CPC H04M 3/42042; H04M 3/436; H04M 1/274508; H04M 3/42153

(57) ABSTRACT

An indication of a call from a first device to a second device is received. The indication includes making the call by a first user using the first device to a second user using the second device. Contextual information about the first user of the first device is received. User preferences of the second user receiving the call using the second device are determined. Responsive to determining the user preferences of the second user of the second device, an action the second device will take is determined based on the user preferences of the second user and the contextual information about the first user.

### BACKGROUND OF THE INVENTION

The present invention relates generally to the field of telecommunication, and more particularly to handling calls based on contextual caller information.

Telecommunication generally includes the transmission, emission, or reception of signs, signals, writings, images, and/or sounds of any nature by wire, radio, optical, or any other electromagnetic system. Channels can be used to transmit information (e.g., electrical signals) over a physical medium (e.g., signal cables or air). Examples of telecommunication technologies include telephones, radios, microwave transmission, fiber optics, and satellites. Examples of telecommunication networks include, but are not limited to, a public switched telephone network (PSTN) (e.g., an analog landline network of telephones, a cellular network for mobile devices, or communication satellites) and the Internet.

Voice over Internet Protocol (VoIP) is a technology that enables a caller to make voice calls using a broadband Internet connection instead of a telephone network, for example by converting analog audio signals into digital data that can be transmitted over the Internet. If a caller using VoIP calls a caller that is using an analog network, the VoIP digital signal is converted to an analog signal before it reaches the caller using the analog network. VoIP can be used on a wired or wireless Internet connection or via an analog telephone adapter.

### SUMMARY

Embodiments of the present invention include a method, computer program product, and system for providing contextual information about an incoming call to a receiver of the call. In one embodiment, an indication of a call from a first device to a second device is received. The indication includes making the call by a first user using the first device to a second user using the second device. Contextual information about the first user of the first device is received. User preferences of the second user receiving the call using the second device are determined. Responsive to determining the user preferences of the second user of the second device, an action the second device will take is determined based on the user preferences of the second user and the contextual information about the first user.

### BRIEF DESCRIPTION OF THE DRAWINGS

FIG. 1 a functional block diagram illustrating a computing environment, in accordance with an embodiment of the present invention;

FIG. 2 a flowchart of operational steps of a call context program for providing contextual call information to a receiving device; and

FIG. 3 depicts a block diagram of components of the computing device of FIG. 1, in accordance with an embodiment of the present invention.

### DETAILED DESCRIPTION

Embodiments of the present invention recognize that, depending on the context of a call, it is not always convenient for the receiver of the call (“the receiver”) to answer the call. However, the receiver does not necessarily know the context of the call. For example, in some instances when it would not be appropriate to answer a non-urgent call, the receiver might want to answer an urgent call. Advantages of some embodiments of the invention include: (i) the receiver gaining context of the call before answering the call and/or (ii) the receiver having the ability to answer calls that are important to him or her, while ignoring calls that he or she is not interested in answering at the moment.

The present invention will now be described in detail with reference to the Figures.

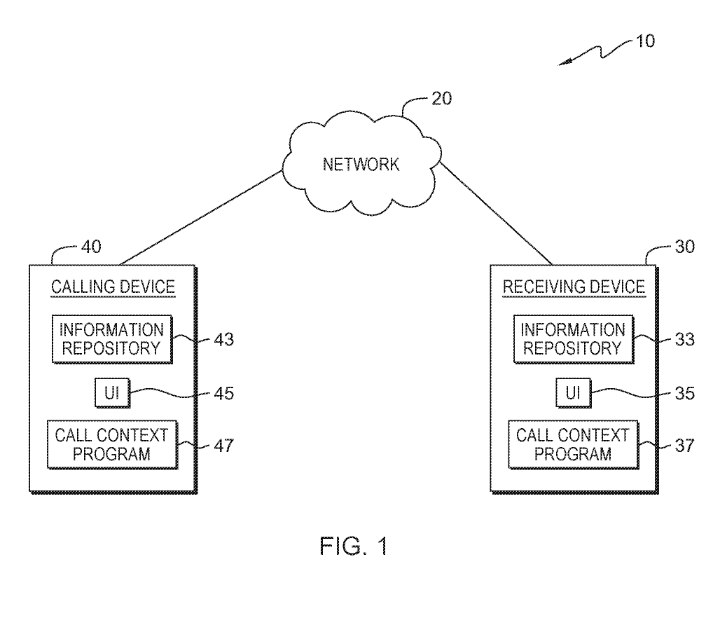

FIG. 1 depicts a diagram of computing environment 10 in accordance with an embodiment of the present invention. FIG. 1 provides an illustration of one embodiment and does not imply any limitations with regard to the environments in which different embodiments may be implemented.

In the depicted embodiment, computing environment 10 includes receiving device 30 and calling device 40 interconnected over network 20. Network 20 may be a local area network (LAN), a wide area network (WAN) such as the Internet, a public switched telephone network (PSTN), any combination thereof, or any combination of connections and protocols that will support communications between receiving device 30 and calling device 40 in accordance with embodiments of the present invention. Network 20 may include wired, wireless, fiber optic, satellite, cellular, or analog connections. Computing environment 10 may include additional computing devices, servers, or other devices not shown.

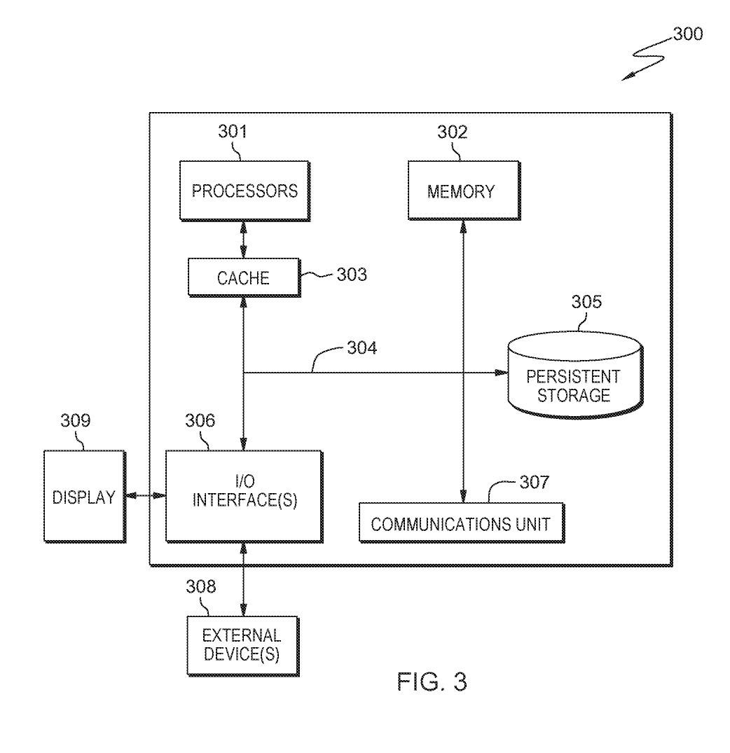

Receiving device 30 may be a desktop computer, laptop computer, tablet computer, personal digital assistant (PDA), or smart phone. In general, receiving device 30 may be any electronic device or computing system capable of executing computer readable program instructions and communicating with calling device 40 over network 20. In an embodiment, receiving device 30 includes information repository 33, user interface (UI) 35, and call context program 37. Receiving device 30 may include components as depicted and described in further detail with respect to FIG. 3.

In an embodiment, information repository 33 is a repository that may be written to and/or read by call context program 37. In an embodiment, information repository 33 stores data such as, but not limited to, user preferences and a list of contacts. The user preferences may be preferences that are preselected by the user of receiving device 30 (i.e., predetermined user preferences). The user preferences inform call context program 37 of the actions that call context program 37 should take when an incoming call is received from a calling device (e.g., calling device 40). User preferences may include, but are not limited to, instructions to let the call continue to ring as normal, auto-route the call to voicemail, generate a callback time, auto-generate and send a message to calling device 40, enable a live feed of sounds heard by calling device 40 to be played as a ringtone on receiving device 30, display sounds and words heard by calling device 40 as text on receiving device 30, and instructions regarding the action(s) that call context program 37 should take when a call is received from a particular caller. In some embodiments, information repository 33 resides on receiving device 30. In other embodiments, information repository 33 may reside on another computing device, provided that information repository 33 is accessible to call context program 37.

Information repository 33 may be implemented using any volatile or non-volatile storage media for storing information, as known in the art. For example, information repository 33 may be implemented with a tape library, optical library, one or more independent hard disk drives, or multiple hard disk drives in a redundant array of independent disks (RAID). Similarly, information repository 33 may be implemented with any suitable storage architecture known in the art, such as a relational database, an object-oriented database, or one or more tables.

UI 35 operates on receiving device 30 to visualize content, such as menus and icons, and to allow a user to interact with an application accessible to receiving device 30. In an embodiment, UI 35 comprises an interface to call context program 37. UI 35 may display data received from call context program 37 and send input received from a user of receiving device 30 to call context program 37. In other embodiments, UI 35 may comprise one or more interfaces such as an operating system interface and/or application interfaces. In example embodiments, a user of receiving device 30 can communicate with call context program 37 via UI 35.

A user interface, as shown by UI 35, is a program that provides an interface between a user and an application. A user interface refers to the information (such as graphic, text, and sound) a program presents to a user and the control sequences the user employs to control the program. There are many types of user interfaces. In an embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. The actions in GUIs are often performed through direct manipulation of the graphics elements.

Call context program 37 operates to determine the context of an incoming call received by receiving device 30 from calling device 40. In an embodiment, call context program 37 prompts the user of receiving device 30 to preselect user preferences. The user preferences indicate to call context program 37 the action(s) call context program 37 should take based on factors (referred to herein as “contextual information”) such as, but not limited to, the identity of the caller, the location of the user of receiving device 30 when the call is received, caller distress (e.g., heart rate, blood pressure, air bag deployment, etc.), deviation from normal routine (e.g., the caller travels a different route than he or she typically travels), weather condition at the location of the caller, traffic information at the location of the caller, time or day of the call, and any other data relevant to determining the context of the call received by receiving device 30. In an embodiment, call context program 37 responds to incoming calls according to the preselected user preferences of the user of receiving device 30. For example, call context program 37 may receive an instruction from the user of receiving device 30 to play, as a ringtone for receiving device 30, a live audio feed of specific words (predefined) and/or specific noises (predefined) that are heard and recorded by calling device 40. In an embodiment, the predefined words and/or noises may be sounds captured in the background or may be sounds that are made directly into calling device 40.

Calling device 40 may be a desktop computer, laptop computer, tablet computer, personal digital assistant (PDA), or smart phone. In general, calling device 40 may be any electronic device or computing system capable of executing computer readable program instructions, and communicating with receiving device 30 over network 20. In an embodiment, calling device 40 is generic and can be any device capable of telecommunication. In an embodiment, calling device 40 contains information repository 43, UI 45, and call context program 47. Calling device 40 may include components as depicted and described in further detail with respect to FIG. 3.

In an embodiment, information repository 43 is a repository that may be written to and/or read by call context program 47. In an embodiment, information repository 43 stores data such as, but not limited to, user preferences and a list of contacts. In an embodiment, user preferences include, but are not limited to, instructions to grant call context program 47 permission to send selected devices (e.g., receiving device 30) contextual information collected by calling device 40. In an embodiment, user preferences vary by individual contact (i.e., user preferences may be customized to an individual or group). In some embodiments, information repository 43 resides on calling device 40. In other embodiments, information repository 43 may reside on another server, or another computing device, provided that information repository 43 is accessible to call context program 47.

Information repository 43 may be implemented using any volatile or non-volatile storage media for storing information, as known in the art. For example, information repository 43 may be implemented with a tape library, optical library, one or more independent hard disk drives, or multiple hard disk drives in a redundant array of independent disks (RAID). Similarly, information repository 43 may be implemented with any suitable storage architecture known in the art, such as a relational database, an object-oriented database, or one or more tables.

UI 45 operates on calling device 40 to visualize content, such as menus and icons, and to allow a user to interact with an application accessible to calling device 40. In an embodiment, UI 45 comprises an interface to call context program 47. UI 45 may display data received from call context program 47 and send input received from a user of calling device 40 to call context program 47. In other embodiments, UI 45 may comprise one or more interfaces such as, an operating system interface and/or application interfaces. In example embodiments, a user (through input via UI 45) of calling device 40 communicates with call context program 47.

A user interface, as shown by UI 45, is a program that provides an interface between a user and an application. A user interface refers to the information (such as graphic, text, and sound) a program presents to a user and the control sequences the user employs to control the program. There are many types of user interfaces. In an embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. The actions in GUIs are often performed through direct manipulation of the graphics elements.

Call context program 47 operates to collect contextual information about the user of calling device 40 and transmit the contextual information to call context program 37. In an embodiment, the user of calling device 40 may preselect user preferences. User preferences include, but are not limited to, enabling call context program 47 to send contextual information to call context program 37, selecting to whom to send contextual call information, and selecting when to send contextual call information. For example, Bob preselects a user preference that enables call context program 47 to send the GPS coordinates of calling device 40 to call context program 37, if Bob calls Cindy. In an embodiment, contextual information includes, but is not limited to, indicators of stress (e.g., heart rate or blood pressure), travel information (e.g., deviation from usual travel route), traffic information (e.g., gridlock traffic), location (e.g., Global Positioning System (GPS) coordinates), background noises (e.g., screams), words or sounds made by the caller, vehicle information (e.g., deployed airbags), environmental conditions (e.g., flood warning), and information scraped from applications (not shown) running on calling device 40 (e.g., information from a social media app). For example, Social Media App A is on calling device 40. A power outage occurs at the location of calling device 40. Call context program 47 receives data from Social Media App A that a significant number of people in the vicinity of calling device 40 are commenting about the power outage. Bob calls Cindy from calling device 40. Call context program 37 receives the contextual information from call context program 47. Call context program 37 displays a message on receiving device 30 to notify Cindy of the comments posted to Social Media App A. Call context program 47 uses natural language processing to determine the context of the comments. Call context program 47 displays, “Power outage at Location A.” Additionally, call context program 47 displays comments posted by users of Social Media App A.

In an embodiment, call context program 47 receives contextual information from another device (not shown) (e.g., a heart monitor). In another embodiment, call context program 47 receives contextual caller information from an application on calling device 40 (e.g., a weather app). In other embodiments, call context program 47 receives contextual caller information from the operating system (not shown) of calling device 40. In an embodiment, call context program 47 and call context program 37 may perform similar functions and may perform any or all steps of the workflow or in conjunction with one another. In an embodiment, call context program 47 is substantially similar to call context program 37.

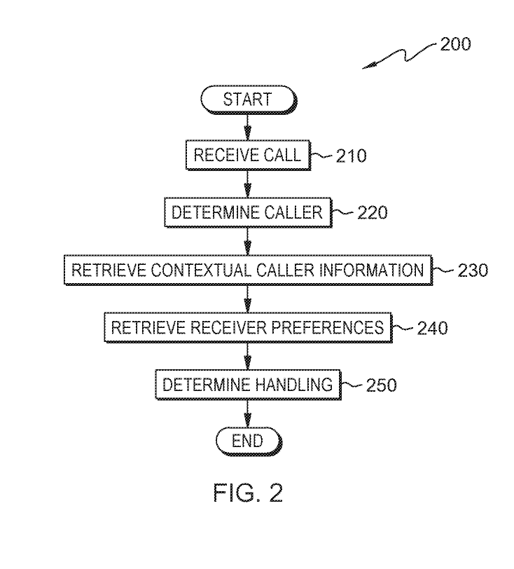

FIG. 2 depicts a flowchart of operational steps 200 of call context program 37 executing within the computing environment of FIG. 1, in accordance with an embodiment of the present invention. Call context program 37 operates to receive contextual information (i.e., the context of the call) from calling device 40 so that the user of receiving device 30 can decide if he or she wants to answer the call. In an embodiment, the steps of the workflow are performed by call context program 37. Alternatively, steps of the workflow can be performed by any other program while working with call context program 37. Call context program 37 can invoke operational steps 200 responsive to receiving device 30 receiving a call from calling device 40.

In step 210, call context program 37 receives an indication of a call. In an embodiment, call context program 37 receives an indication that receiving device 30 is receiving a call from calling device 40. In an embodiment, call context program 37 receives the indication in a form that is standard for the particular form of communication used to place the call (e.g., VoIP or analog telecommunication). In an embodiment, a call is placed via an analog telecommunications network. In another embodiment, a call is placed using VoIP. In other embodiments, a call is placed by any telecommunication protocol that connects two or more callers and/or receivers.

In step 220, call context program 37 determines an identity of the caller. In an embodiment, call context program 37 determines the identity of the caller of calling device 40 by searching a list of contacts stored to information repository 33. For example, call context program 37 receives an indication of a call from calling device 40 that has an associated phone number of (123) 456-7890. Call context program 37 searches information repository 33 and identifies that the phone number (123) 456-7890 is the mobile phone number of Bob Smith. In another embodiment, call context program 37 receives the identity of the caller from another program. For example, call context program 37 receives an indication from a phone application of receiving device 30 that Bob Smith is calling receiving device 30. In an embodiment, if call context program 37 cannot determine the identity of the caller of calling device 40 (e.g., the unique identifier associated with calling device 40, such as a phone number or username, is not recognized as a known contact stored to information repository 33), call context program 37 determines that the caller is an unknown caller. In an embodiment, call context program 37 determines the identity of the caller of calling device 40 to determine the action call context program 37 will take based on the preselected user preferences assigned to the caller by the receiver of receiving device 30.

In step 230, call context program 37 receives contextual caller information associated with the call. In an embodiment, call context program 37 receives contextual caller information from call context program 47. In an embodiment, contextual caller information includes, but is not limited to, indicators of stress (e.g., heart rate or blood pressure), travel information (e.g., deviation from usual travel route), traffic information (e.g., gridlock traffic), location (e.g., Global Positioning System (GPS) coordinates), background noises (e.g., screams), words or sounds made by the caller, vehicle information (e.g., deployed airbags), environmental conditions (e.g., flood warning), and information scraped from applications (not shown) running on calling device 40 (e.g., information from a social media app). In an embodiment, call context program 47 receives contextual information from another device (not shown). For example, call context program 47 receives heart rate information from a device that is monitoring the heart rate of the caller. In another embodiment, call context program 47 receives contextual caller information from an application on calling device 40. For example, call context program 47 receives a weather alert from a weather application on calling device 40. In other embodiments, call context program 37 receives contextual caller information from the operating system (not shown) of calling device 40. For example, call context program 47 receives input that sirens were heard by the microphone (not shown) of calling device 40. In an embodiment, call context program 37 receives contextual caller information from call context program 47 in the form of metadata that are attached to the outgoing call from calling device 40 to calling receiving device 30. In an embodiment, call context program 37 receives information about the caller that was available to call context program 47 when the call was placed (i.e., information gathered at the initiation of the outgoing call by the caller)). In another embodiment, call context program 37 continues to receive information from call context program 37 for the duration of the call (i.e., while ringing, after the call has been answered and is ongoing, or while the caller is leaving a voicemail message).

In an embodiment, call context program 37 receives information based on the user preferences associated with call context program 47. For example, Bob, the user of calling device 40, preselects in the user preferences of call context program 47 that GPS location information, traffic information, weather information, and vehicle information can be sent to call context program 37 when Bob calls Cindy), the user of receiving device 30.

In an embodiment, call context program 37 receives contextual information from a third-party. For example, Bob is a faculty member of University A. Bob registers with Generic Emergency Alert Service provided by University A. Bob selects in the user preferences of call context program 47 that call context program 47 can send information provided by Generic Emergency Alert Service to call context program 37. In the same example, a bear is found walking on the campus of University A. University A is on lockdown. Generic Emergency Alert Service sends an alert to registered users of Generic Emergency Alert Service that the campus is on lockdown due to a bear walking around on the campus of University A. Bob calls Cindy. The alert from Generic Emergency Alert Service is attached to the outgoing call as metadata and is received by call context program 37.

In step 240, call context program 37 retrieves user preferences associated with receiving device 30. In an embodiment, call context program 37 retrieves the preselected user preferences from information repository 33. In an embodiment, the user preferences instruct call context program 37 how to respond to a call (e.g., incoming call) based on contextual information associated with the call. For example, Bob calls Cindy. Call context program 37 retrieves the user preferences that Cindy preselected to determine how to handle calls received from Bob.

In step 250, call context program 37 determines handling of the call. In an embodiment, call context program 37 determines handling of the incoming call based on the identity of the caller, the preselected user preferences, and/or the contextual information associated with the call. In an embodiment, call context program 37 analyzes the received information to determine the nature of the information. In an embodiment, call context program 37 detects the urgency of the call by actions such as, but not limited to, detecting key words spoken by the caller or others in the background heard (e.g., recorded) by call context program 47, detecting signs of distress (e.g., caller biometrics), and analyzing scraped data from applications (e.g., a high number of users of a social network posting that power is down).

In an embodiment, call context program 37 determines how to handle the call by actions such as, but not limited to the following: (i) letting the call continue to ring as normal; (ii) sending the call to voicemail; (iii) scheduling a callback time; (iv) playing a live feed of the voice of the caller and/or the background noises as a ringtone on receiving device 30; (v) generating an auto-response message (e.g., text message); (vi) displaying the words of the caller on receiving device 30; and/or (vii) displaying on receiving device 30, in words, the type of background noises heard by call context program 47.

In an embodiment, call context program 37 retains contextual information received by call context program 47 if there is no response from the user of receiving device 30 (e.g., in the case of a missed call). In an embodiment, call context program 37 periodically sends an alert to the user if call context program 37 does not receive a response from the user. For example, call context program 37 rings and displays an alert in five minute intervals until the user of receiving device 30 interacts with receiving device 30.

In an embodiment, biometrics above or below a determined threshold may indicate that the caller is distressed. For example, a heart rate that is too high or too low (as compared to a predefined threshold) may indicate that the caller is distressed. In an embodiment, call context program 37 analyzes sounds heard by calling device 40 to determine if the user of receiving device 30 should be alerted. In an embodiment, the sounds are compared to pre-defined words and sounds stored in information repository 33. For example, words or phrases such as “Help!” and “Pick up!” indicate to call context program 37 that the call received from receiving device 30 is urgent. In an embodiment, call context program 37 has the ability to distinguish if sounds are human voices, to distinguish the inflection of spoken words, to distinguish words used, to distinguish sounds, and to distinguish any other received input that is received by call context program 47. For example, call context program 37 can detect if a sound is an animal, a siren, thunder, or rumbling.

For example, Bob is stuck in traffic. Bob calls Cindy. Call context program 37 determines that Bob is stuck in gridlock traffic since the GPS coordinates of Bob have remained the same for twenty minutes and from receiving a traffic report from the GPS device that indicates the extent of the traffic congestion. In another example, Bob is wearing a watch that is linked to an insulin pump. Call context program 47 receives data that includes the blood sugar level of Bob from the watch. Bob calls Cindy. Call context program 37 receives data that indicates that Bob has a blood sugar level that is too low (i.e., below a predefined threshold) and determines that the call is urgent. In yet another example, Bob is driving. Calling device 40 is linked to a vehicle diagnostic program in the car Bob is driving. While driving, Bob gets a flat tire. Call context program 47 receives input from the vehicle diagnostic program that the tire is flat. Bob calls Cindy. Call context program 37 receives the diagnostic information from call context program 47. Call context program 37 determines the call is urgent based on the diagnostic information.

In an embodiment, call context program 37 may respond to received input in various ways (e.g., based on user preferences). For example, Cindy has her phone on silent. Bob calls Cindy. Call context program 37 determines that Bob is yelling, “Help!” Based on the user preferences preselected by Cindy, call context program 37 plays a live feed of Bob as a ringtone on receiving device 30. In another embodiment, Bob is in an area that is flooded. Bob calls Cindy. Based on the contextual information provided by call context program 47, call context program 37 determines that Bob is calling from a flooded area. Call context program 37 flashes a text alert on receiving device 30, in addition to playing an alarm sound as the ringtone. In yet another example, Bob calls Cindy. Call context program 37 determines that the car that Bob is driving is experiencing engine failure. Call context program 37 flashes a text message on the receiving device 30. Cindy is away from receiving device 30 and misses the call from Bob. Call context program 37 incrementally flashes an alert on receiving device 30 until Cindy interacts with receiving device 30.

In an embodiment, processing ends when the user of calling device 40 or the user of receiving device 30 terminates the call, when the user of receiving device 30 answers the call, or when the call is sent to voicemail.

FIG. 3 depicts computer system 300, which is an example of a system that includes call context program 37. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage x05 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for providing contextual information about an incoming call to a receiver of the call, the method comprising:
receiving, by one or more computer processors, an indication of a call from a first device to a second device, wherein the indication includes making the call by a first user using the first device to a second user using the second device;
receiving, by one or more computer processors, contextual information about the first user of the first device;
determining, by one or more computer processors, a user preference based on the second user receiving the call using the second device; and
responsive to determining the user preferences of the second user of the second device, determining, by one or more computer processors, an action the second device will take based on the user preference and the contextual information about the first user.

2. The method of claim 1, wherein the contextual information the group consisting of an identity of the first user, a location of the first user when the call is received by the second user, stress experienced by the first user, deviation from normal routine of the first device, weather conditions at the location of the first device, traffic information at the location of the first device, words detected by the first device, sounds detected by the first device, vehicle information of the first user, environmental conditions at the location of the first device, and information scraped from applications running on the first device.

3. The method of claim 1, wherein the user preference of the second user of the call is selected from the group consisting of predetermined instructions for how to respond to calls based on an identity of the first user, predetermined instructions for how to respond to calls based on the context of the call, predetermined instructions for how to respond to calls based on a time of day the call is received, predetermined instructions for how to respond to calls based on a day of a week the call is received, and predetermined instructions for how to respond to calls based on a location of the second user when the call is received.

4. The method of claim 1, wherein the action is selected from the group consisting of send the call to voicemail, allow the call to continue to ring, alert the second user of the call, play a live feed of an audio heard and recorded by the first device as a ringtone on the second device, display an audio heard by the first device on a screen of the second device, generate an auto-response message, retain contextual data of the first user if there is no response from the second user, and periodically send an alert to the second user if no response was received from the second user.

5. The method of claim 1, further comprising:
indicating, by one or more computer processors, to the second device to take the determined action.

6. The method of claim 1, further comprising:
determining, by one or more computer processors, an identity of the first user; and
wherein the step of responsive to determining the user preference of the second user of the second device, determining, by one or more computer processors, an action the second device will take based on the user preference of the second user and the contextual information about the first user comprises:
responsive to determining the user preference of the second user of the second device, determining, by one or more computer processors, an action the second device will take based on the user preference of the second user, the determined identity of the first user, and the contextual information about the first user.

7. The method of claim 6, wherein the identity of the first user is determined from the group consisting of a list of contacts stored to the second device and a unique identifier associated with the first device.

8. A computer program product for providing contextual information about an incoming call to a receiver of the call, the computer program product comprising:
one or more computer readable storage media; and
program instructions stored on the one or more computer readable storage media, the program instructions comprising:
program instructions to receive an indication of a call from a first device to a second device, wherein the indication includes making the call by a first user using the first device to a second user using the second device;
program instructions to receive contextual information about the first user of the first device;
program instructions to determine a user preference based on the second user receiving the call using the second device; and
program instructions, responsive to determining the user preferences of the second user of the second device, to determine an action the second device will take based on the user preference and the contextual information about the first user.

9. The computer program product of claim 8, wherein the contextual information the group consisting of an identity of the first user, a location of the first user when the call is received by the second user, stress experienced by the first user, deviation from normal routine of the first device, weather conditions at the location of the first device, traffic information at the location of the first device, words detected by the first device, sounds detected by the first device, vehicle information of the first user, environmental conditions at the location of the first device, and information scraped from applications running on the first device.

10. The computer program product of claim 8, wherein the user preference of the second user of the call is selected from the group consisting of predetermined instructions for how to respond to calls based on an identity of the first user, predetermined instructions for how to respond to calls based on the context of the call, predetermined instructions for how to respond to calls based on a time of day the call is received, predetermined instructions for how to respond to calls based on a day of a week the call is received, and predetermined instructions for how to respond to calls based on a location of the second user when the call is received.

11. The computer program product of claim 8, wherein the action is selected from the group consisting of send the call to voicemail, allow the call to continue to ring, alert the second user of the call, play a live feed of an audio heard and recorded by the first device as a ringtone on the second device, display an audio heard by the first device on a screen of the second device, generate an auto-response message, retain contextual data of the first user if there is no response from the second user, and periodically send an alert to the second user if no response was received from the second user.

12. The computer program product of claim 8, further comprising program instructions, stored on the one or more computer readable storage media, to:
indicate to the second device to take the determined action.

13. The computer program product of claim 8, further comprising program instructions, stored on the one or more computer readable storage media, to:
determine an identity of the first user; and
wherein program instructions, responsive to determining the user preference of the second user of the second device, to determine an action the second device will take based on the user preference of the second user and the contextual information about the first user comprises:
program instructions, responsive to determining the user preference of the second user of the second device, to determine an action the second device will take based on the user preference of the second user, the determined identity of the first user, and the contextual information about the first user.

14. The computer program product of claim 13, wherein the identity of the first user is determined from the group consisting of a list of contacts stored to the second device and a unique identifier associated with the first device.

15. A computer system for providing contextual information about an incoming call to a receiver of the call, the computer system comprising:
one or more computer processors;
one or more computer readable storage media; and
program instructions stored on the one or more computer readable storage media for execution by at least one of the one or more processors, the program instructions comprising:
program instructions to receive an indication of a call from a first device to a second device, wherein the indication includes making the call by a first user using the first device to a second user using the second device;
program instructions to receive contextual information about the first user of the first device;
program instructions to determine a user preference based on the second user receiving the call using the second device; and
program instructions, responsive to determining the user preferences of the second user of the second device, to determine an action the second device will take based on the user preference and the contextual information about the first user.

16. The computer system of claim 15, wherein the contextual information the group consisting of an identity of the first user, a location of the first user when the call is received by the second user, stress experienced by the first user, deviation from normal routine of the first device, weather conditions at the location of the first device, traffic information at the location of the first device, words detected by the first device, sounds detected by the first device, vehicle information of the first user, environmental conditions at the location of the first device, and information scraped from applications running on the first device.

17. The computer system of claim 15, wherein the user preference of the second user of the call is selected from the group consisting of predetermined instructions for how to respond to calls based on an identity of the first user, predetermined instructions for how to respond to calls based on the context of the call, predetermined instructions for how to respond to calls based on a time of day the call is received, predetermined instructions for how to respond to calls based on a day of a week the call is received, and predetermined instructions for how to respond to calls based on a location of the second user when the call is received.

18. The computer system of claim 15, wherein the action is selected from the group consisting of send the call to voicemail, allow the call to continue to ring, alert the second user of the call, play a live feed of an audio heard and recorded by the first device as a ringtone on the second device, display an audio heard by the first device on a screen of the second device, generate an auto-response message, retain contextual data of the first user if there is no response from the second user, and periodically send an alert to the second user if no response was received from the second user.

19. The computer system of claim 15, further comprising program instructions, stored on the one or more computer readable storage media for execution by at least one of the one or more computer processors, to:
determine an identity of the first user; and
wherein program instructions responsive to determining the user preference of the second user of the second device, to determine an action the second device will take based on the user preference of the second user and the contextual information about the first user comprises:
program instructions, responsive to determining the user preference of the second user of the second device, to determine an action the second device will take based on the user preferences of the second user, the determined identity of the first user, and the contextual information about the first user.

20. The computer system of claim 19, wherein the identity of the first user is determined from the group consisting of a list of contacts stored to the second device and a unique identifier associated with the first device.
